(19) United States
(12) Patent Application Publication
(10) Pub. No.: US 2002/0010911 A1
(43) Pub. Date: Jan. 24, 2002

(54) Compile time pointer analysis algorithm statement of government interest

(76) Inventors: Ben-Chung Cheng, Milpitas, CA (US); Wen-mei Hwu, Champaign, IL (US)

Correspondence Address: Steven P. Fallon, GREER, BURNS & CRAIN, LTD., 300 South Wacker Drive, 25th Floor, Chicago, IL, 60606, US

(21) Appl. No.: 09/770,029

(22) Filed: Jan. 25, 2001

Related U.S. Application Data
(60) Provisional application No. 60/182,769, filed on Feb. 16, 2000.

(51) Int. Cl. G06F 9/44

(52) U.S. Cl. 717/4

(57) ABSTRACT

In compiling a program, the present algorithm first analyzes each function in the program as an isolated compilation unit where parameters and global variables are temporarily assumed to have uninitialized values. This stage of the algorithm, the intraprocedural phase, will summarize the intraprocedural behavior of a function in a flow-insensitive manner, including how it can affect memory accesses in the caller and callee functions, and how its memory accesses can be affected by the caller and callee functions. The summarized behavior of each function is the only information to be processed in the next stage, the interprocedural stage. A significant size reduction is achieved in the summarized representation as compared to the full function body. This facilitates aggressive optimization of even large programs.

### REFERENCE TO RELATED APPLICATION AND PRIORITY CLAIM

This application is related to and claims priority under 35 USC §119(e) from prior provisional application Serial No. 60/182,769, filed on Feb. 16, 2000.

### STATEMENT OF GOVERNMENT INTEREST

This invention was made with government support under National Science Foundation CCR-9809478. The government has certain rights in this invention.

### FIELD OF THE INVENTION

The present invention concerns software compilers.

### BACKGROUND OF THE INVENTION

A wide-issue superscalar processor cannot sustain its peak speed unless the memory system can provide data at the same rate as they are consumed by the processor. Since the performance gap between the processor and the memory keeps growing, the memory access latency has an even greater impact on performance, motivating the need for techniques that either eliminate memory instructions or at least tolerate the latency of load instructions.

Hardware techniques that can hide the latency of load instructions have been investigated in the past. The hardware mechanisms do not eliminate load instructions contained in the program. Predictive caching methods anticipate, but similarly do not eliminate, load instructions.

Another set of known techniques use the software compiler to aggressively transform load and store instructions under the guidance of static memory disambiguation information. A particularly effective method concerns register promotion, the moving of targeted memory contents into the processor registers at compile time. This allows instructions to communicate through registers instead of the memory, thus avoiding the latency of memory calls for the targeted contents. If register promotion is not possible due to hazardous memory instructions or function calls, a less ambitious approach schedules load instructions in advance of their original position. This advance approach may be conducted until a potentially conflicting store is reached. In this way, either the entire memory latency or a portion of it can be hidden. However, the compiler can only disambiguate direct accesses to local variables. Indirect accesses to local variables or accesses to global variables can only be disambiguated in a very limited code scope, which may be even smaller than a basic block. Given a program with intensive usage of pointers and function calls, analysis in such a scope can only provide modest performance gains. Interprocedural pointer analysis would solve some of these difficulties, but it is not viewed as practical to be conducted in commercial compilers. Dynamic memory disambiguation mechanisms are generally used as alternative approaches to tolerate the memory latency.

There is therefore a need for an improved pointer analysis algorithm which achieves memory disambiguation. The present invention meets this need and provides a compile time pointer analysis algorithm. The present algorithm addresses memory latency by providing a compiler which achieves an aggressive static memory disambiguation.

### SUMMARY OF THE INVENTION

In compiling a program, the present algorithm first analyzes each function in the program as an isolated compilation unit where parameters and global variables are temporarily assumed to have uninitialized values. This stage of the algorithm, the intraprocedural phase, will summarize the intraprocedural behavior of a function in a flow-insensitive manner, including how it can affect memory accesses in the caller and callee functions, and how its memory accesses can be affected by the caller and callee functions. The summarized behavior of each function is the only information to be processed in the next stage, the interprocedural stage. A significant size reduction is achieved in the summarized representation as compared to the full function body. This facilitates aggressive optimization of even large programs.

A static algorithm often needs to use an abstract notation to represent run-time accessed memory locations. Conventionally, storage-based representation is often adopted that uses extended variable names for physical memory locations. To avoid ambiguity, it is often required that a single memory location cannot be represented by more than one storage name. Due to different aliases among formal parameters, more than one version of transfer functions, either separately maintained or collectively maintained but differentiated by alias contexts, are required. Access paths, on the other hand, simply represent physical memory locations by how they are accessed from an initial variable in a store-less model. As long as the length of access paths can be bound in the presence of recursive data structures, a context-independent representation of the summary transfer function and an easier way to produce unique names for heap objects can be enabled. However, the past work does not explain how summary transfer functions are to be maintained in access paths. In a preferred embodiment of the present invention, a new closure function, EVAL, is defined to enable the operation of summary transfer functions using access paths. The EVAL function achieves three major tasks. First, it normalizes an access path into its right-most forms so that fewer access paths and points-to relations are generated. Second, the EVAL function references points-to relations in different calling contexts to re-evaluate a single access path into new right-most forms in different calling contexts so that a single context-independent representation of a summary function can enable a context-sensitive analysis. Third, the EVAL function can generate unique names for heap objects without the need to know where heap objects are exactly allocated.

### BRIEF DESCRIPTION OF THE DRAWINGS

FIG. 1 illustrates a preferred embodiment of the present invention;

FIG. 2 illustrates the constructing of points-to relations from pointer assignments: (a) code, (b) corresponding points-to relations for each assignment;

FIG. 3 illustrates handling access paths involving recursive data types: (a) results of the first iteration, (b) results of the second iteration, (c) results controlled by k=1;

FIG. 4 illustrates an algorithm for inserting interface variables;

FIG. 5 illustrates an algorithm for the intraprocedural pointer analysis stage of FIG. 1;

FIG. 6 illustrates a code example with interface variables;

FIG. 7 illustrates results of intraprocedural pointer analysis on the code of FIG. 6;

FIG. 8 illustrates an example of function summary behavior;

FIG. 9 illustrates handling heap objects: (a) code example, (b) function summary behavior, (c) representing dependence among accesses to heap objects;

FIG. 10 illustrates an algorithm for constructing extended access paths;

FIG. 11 illustrates a pass of function names across functions: (a) code example, (b) summary behavior, (c) information obtained after the first invocation of phase I″, (d) information obtained after the first invocation of phase II′; and

FIG. 12 illustrates pseudo code of the interprocedural pointer analysis stage of FIG. 1.

### DETAILED DESCRIPTION OF THE INVENTION

The present compile time pointer analysis algorithm uses an intraprocedural behavior function summary and uses the summarized behavior in resolving pointers in an interprocedural analysis. The propagation of summary transfer functions is conducted in a context-sensitive but inexpensive manner using access paths and points-to analysis. Memory requirements are controlled and accuracy maintained in the presence of function pointers by starting with an under-estimated call graph that is augmented iteratively along the course of interprocedural pointer analysis. The offset representation for structure/union fields is also incorporated into access paths to seamlessly handle aliases caused in C and C++ by unions and type casts. The number for recursive heap objects can be bound and the location of acyclic heap objects can be easily disambiguated using access paths.

Memory accesses in programs written by modern programming languages often have aliases due to either general pointers or call-by-reference parameters. For example, although the Fortran language does not have general pointers, a single array can be accessed via different dimensions in different functions through parameters. In C, C++, and Java, heap objects can be allocated on the programmer's discretion, and the addresses of stack objects can also be taken and propagated throughout the program, therefore they greatly hinder the distinction of memory accesses' final locations. In addition, C and C++ allow the arbitrary use of type casts to manipulate pointers beyond the fence set by types in the software program, further hardening the memory disambiguation task.

The commonly used C programming language provides a convenient syntax for illustrating the method of the invention. As briefly described above, the pointers to be resolved in C programs at compile time by the present invention find correspondence in other programming languages. Artisans will accordingly appreciate that the invention is therefore equally applicable to compilers for any programming language in which supports pointers having indirect accesses to local variables of a program function or accesses to global variables of multiple program functions.

In its preferred embodiment, the algorithm of the present invention has two major stages: an intraprocedural stage and an interprocedural stage. In the intraprocedural stage, each function is analyzed as an isolated compilation module where formal parameters, callee return values, and global variables are all assumed to have unknown values. Indirectly accessed locations through unknown pointers are represented by access paths. By the end of the intraprocedural stage, a summary behavior of each function is calculated, including a set of memory locations accessible across function boundaries, a set of call-site names, a set of pointer definitions involving pointers accessible across function boundaries, a set of pointer assignments involving formal parameters and global variables.

The modular algorithm in this invention first tackles the interprocedural nature of pointer analysis by reducing the amount of memory requirement. This is applicable to all programming languages which may contain memory aliases across function boundaries. The access path notation defined in this invention also resolves aliases existing among heap objects and indirectly accessed stack objects, which are ubiquitous in C, C++, and Java. The byte-level offset representation for fields in aggregates further disambiguates memory aliases caused by type casts and unions as those contained in C and C++ programs.

The third set (of pointer assignements) is considered as the summary transfer function and represented by points-to relations. In the interprocedural stage, bottom-up propagation of summary transfer functions along the call graph is performed. In the presence of function pointers, a top-down propagation of function names along the partially resolved call graph is also conducted, since some indirect call-sites may receive concrete function names through parameters. Because the transfer function of a just-discovered indirect callee may define function pointers used elsewhere in the program, the bottom-up and top-down propagations need to be performed iteratively until a fixed point is reached. The aliases among formal parameters are then calculated after top-down propagation of concrete values along the complete call graph. In the method of the invention, access paths enable a context-independent representation of transfer functions so that the memory overhead used to represent multiple versions of summary transfer functions is reduced.

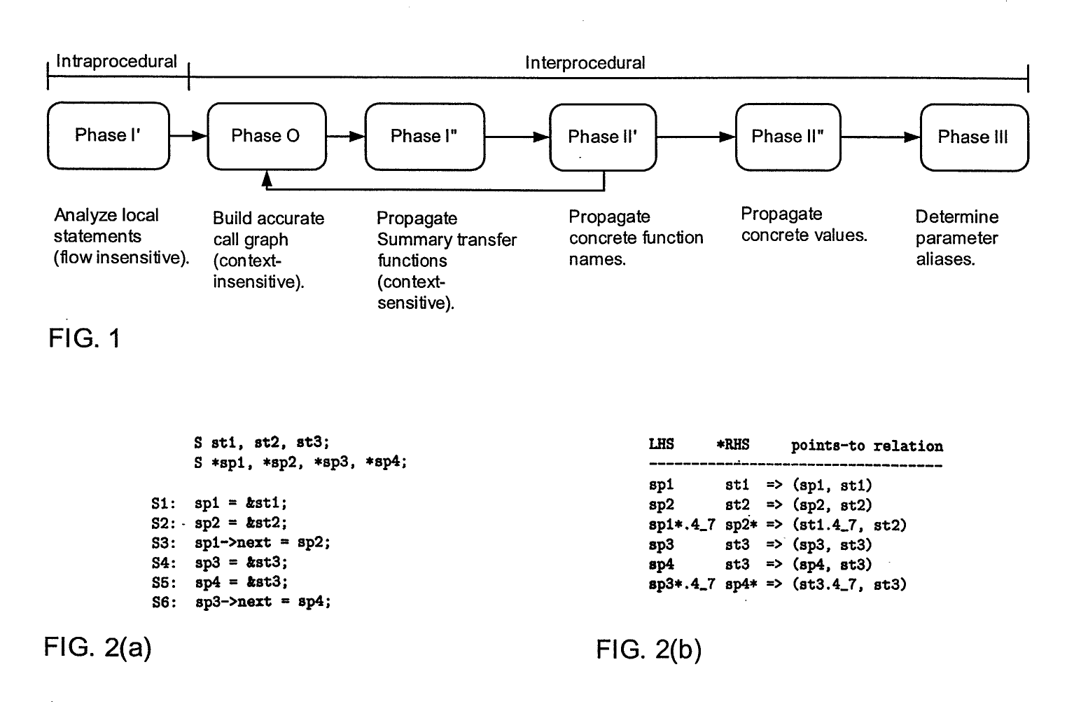

Turning now to the drawings, FIG. 1 illustrates the preferred algorithm of the invention. It is convenient to parse the algorithm into five phases as shown in FIG. 1 to aid understanding, but the invention is not limited to the divisions of tasks shown in the preferred FIG. 1 embodiment. In FIG. 1, the intraprocedural stage is conducted first and is completely contained in phase I′, where assignment statements in each function are analyzed by assuming that all parameters and global variables have unknown values. By the end of this phase, indirect memory accesses using parameters and global variables can be identified and collected for future analysis in the interprocedural stage. Phase 0, I″ and II′ are the first three phases in the interprocedural stage. These three phases are iterative where phase 0 updates the call graph by accommodating function pointers resolved by phase I″ and II′ of the previous iteration, phase I″ conducts the aforementioned bottom-up analysis to propagate summary transfer functions, and phase II′ conducts the aforementioned top-down analysis to propagate function names passed as parameters. When a fixed point is reached for these iterative phases, all passed parameter values are collected in a top-down fashion along the call graph in phase II″ and then the dependence among indirectly accessed locations dereferenced from parameters are determined in phase III.

The numbering of these phases are adopted from the prior art of Relevant Context Inference (RCI) from Chatterjee et al., Proceedings of the ACM Symposium on Principles of Programming Languages, p. 133-146, January 1999, for easy comparison. In their algorithm, there are only distinguished phases as Phase 0, I, II, and III, conducted in the ascending order of the phase numbers without minor phases. Since the call graph is conservatively estimated to accommodate function pointers, phase 0 can be conducted before any pointer analysis starts. However, our initial study indicates that such analysis paradigm will result in inaccurate results in addition to lengthened analysis time. Phase I in RCI is flow-sensitive and context-sensitive. In our invention, it is separated into phase I′ which is flow-insensitive; and phase I″ which is context-sensitive. While phase I in RCI requires the whole function body of multiple functions to be memory-resident, in this invention phase I′ only requires one function body and phase I″ only requires two function summary behaviors to be memory resident, greatly reducing the memory consumption overhead. Phase II′ in our invention is a light-weighted version of Phase II in RCI since only function-type parameter values are passed. After the call graph is finalized, phase II″ is conducted to propagate all pointer-types concrete values. Phase III analyses from RCI and the invention are identical.

### INTRAPROCEDURAL POINTER ANALYSIS

Pointer analysis is a data-flow analysis which deals with the flow of pointer values. Given two pointers p1 and p2, they cannot point to the same location unless they are initialized by the same value, so the fundamental job in a pointer analysis algorithm is to analyze pointer assignments to calculate the flow of pointer values. In compilers for programming languages that allow multi-level pointers, e.g., the C language, a correct pointer analysis algorithm needs to deal with aliases of pointers as well. Once the address of a pointer is passed to another function, pointer analysis needs to be conducted in the interprocedural scope otherwise some pointers cannot be resolved.

The intraprocedural pointer analysis of the invention addresses how to handle pointer assignments and determine aliases among pointers. Pointers defined through local statements can be fully resolved in the intraprocedural stage. Pointers defined through function calls are only identified in the intraprocedural stage and will be resolved in the interprocedural stage. These interprocedurally accessible pointers are represented in a context-independent format using access paths, based on which a summary behavior of each function is constructed, including MOD/REF information for interprocedurally accessible locations, callee information and summary transfer functions. The summarized behavior is the only data structure to be maintained in the interprocedural stage. This limits analysis time and memory usage.

### ACCESS PATHS

For a C expression that accesses the memory, an access path can be as simple as a direct access to a variable, or an indirect access through a sequence of dereference operations with offset adjustments. Since different variables represent different memory locations, disambiguating accesses of the former case is simple. To disambiguate accesses of the latter case, both the sequence of dereference and offset operations and the contents of intermediate pointers are required.

An access path is a string recording the sequence of intermediate dereference and offset operations to meet the first requirement of memory disambiguation. Described in regular expressions, the grammar of an access path may be stated as v(fd|d)*(f|ε). The initial token, v, is simply a variable name. Symbol f is of the form “.so_eo”, which denotes the starting and end offsets of a field in a structure/union, and symbol d denotes the dereference operation and may symbolically be shown as “*” elsewhere when there is no confusion with the closure symbol in regular expressions. Unless the contents of intermediate pointers in an access path are known, an access path is simply an encoded postfix string and is not bound with any particular locations, but simply represents how the denoted location is accessed.

Illustration of the intraprocedural phase is now conducted with respect to a C program.

Definition 1. (Construction of access paths). AP denotes the function that recursively determines the postfix access path for a C expression:

$$\begin{matrix}AP ( v ) = v & ( 1 ) \\ AP (* exp ) = \{ \begin{matrix}AP ( exp ) & if exp is a function name \\ AP ( exp ) * & otherwise\end{matrix} & ( 2 ) \\ AP (* exp [ index ] ) = \{ \begin{matrix} AP ( exp ) & if exp is of an array type but not a formal parameter \\ AP ( exp ) * & otherwise\end{matrix} & ( 3 ) \\ AP ( exp op exp 1 ) = AP ( exp ) & ( 4 ) \\ AP ( exp \cdot field ) = AP ( exp ) * so \_ eo & ( 5 ) \\ NM ( α sol \_ eol \cdot so2 \_ eo2 ) = α \cdot so3 \_ eo3 & ( 6 ) \\ AP ( exp \to field ) = AP ( exp ) * so \_ eo & ( 7 )\end{matrix}$$

where so3 =so1 +so2 and eo3 =so1 +eo2.

Instead of generating all possible access paths from any variables, access paths are generated lazily, i.e., on an as needed basis such that only objects and fields which are accessed are generated with access paths, from observed C expressions in each function. Definition 1 shows the rules that recursively determine the access path of a C expression. Rule 1 is the terminal case which initiates the access path with the corresponding variable name. Rule 2 handles the dereference operation by appending a “*” symbol after the access path corresponding to the being dereferenced pointer expression unless the prefix string is a function name. The C language grammar allows function names to be dereferenced, but at run-time the dereference does not occur, which is reflected in Rule 2. Similarly, Rule 3 handles the duality between array and pointer accesses. If the array expression truly has an array type and is not a formal parameter, no dereference is necessary since the expression accesses a constant location; otherwise a “*” symbol is appended. As shown by Rule 4, explicit pointer arithmetics are ignored by the AP function, resulting in a coarse but safe access path for linearly accessed locations. However, offsets added to pointers by the field operators, “.” and “→”, are faithfully represented in access paths since they are always constants and can therefore be accurately determined.

Traditionally, fields in access paths are represented by their symbolic names. Although symbolic names serve the purpose to differentiate individual fields in a structure, they do not provide adequate information regarding the aliases caused by unions and type casts. For example, given a nested structure field access s1.s2.f1 where f1 is the first field in structure s2, type casts alone without any pointer assignments can create an alternative expression, ((struct*S2)(&s1))→f1, to access the same f1 field. This is because the programmer can take advantage of the knowledge that the address of a structure is the same as the address of the first field of the structure. When symbolic names for fields are used, two different access paths result: s1.s2.f1 and s1.f1, respectively. They can be explicitly marked as aliases with extra annotations, but offsets for structure fields provide a better solution. In Rules 5 and 6, the starting offset (so) and end offset (eo) of a field relative to the in-most enclosing structure are calculated and used to represent the field. Assuming the size of s2 is 100 bytes and f1 occupies 4 bytes in s2, the encoded access path of s1.s2.f1 is si.0_{—}99.0_{—}3, while the encoded access path of ((struct*S2)(&s1))→f1 is is s1.0_{—}3. Then Rule 7 is defined so that back-to-back field offsets are coalesced into a single field by translating the relative offsets from the in-most enclosing structure to the out-most one. The normalization simply proceeds by adding the starting offset of the enclosing structure to the starting and end offsets of the enclosed field. For example, the normalized access path of s1.0_{—}99.0_{—}3 is s1.0_{—}3, since 0+0=0 and 0+3=3. As a result, two aliased expressions have a common access path based on normalized field offsets. Without explicit pointer assignments, access paths using byte offsets can resolve aliases caused by type casts and pointer arithmetics. The next section discusses how the invention resolves aliases in the presence of arbitrary pointer assignments.

### RIGHT-MOST ACCESS PATHS AND POINTER ASSIGNMENTS

The points-to relation present by Emami et al., “Context-Sensitive Interprocedural Points-To Analysis in the Presence of Function Pointers”, is also adopted in the invention to represent the data-flow facts of pointer assignments. The points-to relation is a general binary relation between a pointer and its target. The original points-to relation is of the form (p, t, P |D) where p and t are two storage names representing physical pointer and target memory locations, respectively. The third operand, P |D, specifies whether the pointer possibly, or definitely points to the target. In the points-to notation defined for preferred embodiment of the invention, both p and t are represented in access paths, and the P |D attribute is not used since only possible points-to relations are generated. Thus, the interprocedural phase of the invention generates possible points-to relations without any definite points-to relations.

Given a pointer assignment 1hs=rhs where both 1hs and rhs are pointer-type C expressions and rhs is not NULL, the first step of determining the corresponding points-to relations is to construct the corresponding access paths for 1hs and *rhs, noticing the dereference operator added to the rhs expression. Due to the effects of earlier pointer assignments, 1hs and *rhs may have aliases. For example, given a pointer p and a prior pointer assignment q=&p, both access paths, p, q*, are aliases. Similarly, given a pointer r and a prior pointer assignment r=&i, r* and i are also aliases. As a result, any of the following four statements can cause p to point to i: p=&i, p=r, *q=&i, or *q=r.

Definition 2 (Right-most access path). Given a direct access to a variable, its right-most access path is simply the variable's name. If a memory location is accessed indirectly, its right-most access path is contrived based on the access paths of the pointers that appear as the very first RHS operand in a sequence of pointer assignments that propagate the address of the indirectly accessed memory location.

One way to correctly represent the effects of the above set of pointer assignments is to create four points-to relations using the cross products of all aliases of the pointer and all aliases of the target as (p, i), (p, r*), (q*, i), and (q*, r*). However, the complete enumeration is unnecessary since there are ways to transform an access path into a normalized form based on the observations that aliases are caused by pointer assignments, and pointers must be initialized before they can be used. So for every pointer dereference, there must be one or a small number of right-most access paths, as explained in Definition 2, which denote the accessed memory location whose addresses are assigned to the dereferenced pointer through an arbitrary number of pointer assignments. As long as all encoded access paths from C expressions can be normalized to the right-most access paths, fewer access paths are ended up and therefore fewer points-to relations need to be maintained. Definition 3 shows how to use the encoded access path from a C expression and existing points-to relations to find the entire set of right-most access paths, where Definition 4 shows how to add points-to relations based on right-most access paths for a pointer assignment. Notice that the evaluated result is a set of access paths instead of a singular path due to the fact that a pointer may have more than one definition. This is either caused by conditional definitions made to a pointer or the flow-insensitive nature of the pointer analysis algorithm.

Definition 3 (Finding the right-most forms of an access path) Under a set of points-to relations S_{PTR}, the evaluation function, EVAL, recursively parses an access path and returns the entire set of right-most access paths as defined below:

EV AL(v|(&v)*, S_{PTR}={v} (8)

EV AL(α*, S_{PTR})={β|∃θε EV AL(α, S_{PTR}), (θ, β)εS_{PTR}} (9)

EV AL(αf, S_{PTR})={γ|∃θε EV AL(α, S_{PTR}), γ=NM(θf)} (10)

EV AL(α*, S_{PTR})={θ|∃θε EV AL(α, S_{PTR}), (θ, β)∉S_{PTR}} (11)

EV AL(α*, S_{PTR})={δ|∃θε EV AL(α, S_{PTR}), δ_{n≦k}λ=θ} (12)

Definition 4 (Path-based points-to relations). Given a pointer assignment lhs=rhs in function fn where both lhs and rhs are pointer-type C expressions and rhs is not NULL, let S_{PTR} be the set of points-to relations already added for fn. For every πεEVAL(AP(1hs), S_{PTR}) and τεE EVAL(AP(*rhs), S_{PTR}), points-to relation (π, τ) is added to SPTR.

EVAL is a closure function which takes an access path and a set of points-to relations and then returns the set of right-most aliases of the input path. Rule 8 handles the trivial case where no dereference is encountered, or the dereference is simply canceled by address operator (&). Since the trivial case accesses a definitive memory location, the right-most access path is simply the variable itself. For an access path containing a sequence of dereference and offset operations, the path is processed by parsing the composing operations, or tokens, from left to right, reflecting the actual sequence of memory dereferences that would occur at run-time. Rule 9 addresses the case where the next token is a dereference operation and the pointer access path has outgoing points-to relations, meaning that the pointer is initialized. Since the tokens are parsed from left to right, the evaluation result of α is already available before a* is evaluated. Then, for each access path θ found in EVAL(α, Sₚₜᵣ), the targets of θ's points-to relations are the right-most aliases of α*. Rule 10 handles the offset token by concatenating the offset to each path found in the evaluation result of the prefix path. Back-to-back fields also need to be normalized. This whole process can be considered as following the fan-out tree of a set of points-to relations where the root is the initial variable in the access path.

Rules 11 and 12 will be ignored for now and the example in FIG. 2 will be considered first. FIG. 2a list code. The left part of FIG. 2b lists the encoded access paths for lhs and *rhs before EVAL is invoked. The right part of FIG. 2 lists the added points-to relations for each statement based on the right-most access paths. For statements S1 and S2, the encoded access paths from C expressions have no dereference operators so only Rule 8 is applied when evaluating the access paths. For statement S3, the right-most access path of the expression is st1.next, or st1.4_{—7 in byte offsets, which can be discovered in three steps:}

1: EV AL(sp1, {(sp1, st1), (sp2, st2)})={sp1}

2: EV AL(sp1*, {(sp1, st1), (sp2, st2)})={st1}

3: EV AL(sp1*.4_{—7, {(sp1, st1), (sp2, st2)})={st1.4}_{—7}}

Similarly, the right-most access path of the memory location pointed to by the expression is st2, which can be discovered in two steps:

1: EV AL(sp2, {(sp1, st1), (sp2, st2)})={sp2}

2: EV AL(sp2*, {(sp1, st1), (sp2, st2)})={st2}

As a result, the points-to relation added for statement S3 is (st1.4_{—7, st2). The points-to relations added for statements S4, S5, and S6 can be derived in the same manner.}

Rules 8 through 10 in Definition 3 guarantee that all initialized pointers must point to at least one right-most access path after being evaluated. Rule 11 generates temporary right-most access paths for indirectly accessed locations from uninitialized pointers. This situation can arise when parameters and global variables are assumed as uninitialized in the intraprocedural stage of the modular interprocedural analysis algorithm and the function body contains expressions which dereference from these pointers. The straightforward way, as denoted by Rule 11, is to append a “*” symbol after the right-most access paths of the dereferenced pointer. For indirect accesses using pointers of non-recursive types, there are a finite number of locations that can be reached from the pointer, so the total number of access paths that can be generated from the pointer is finite. However, when uninitialized pointers to recursive data structures are involved, infinite access paths may be produced by Rule 11.

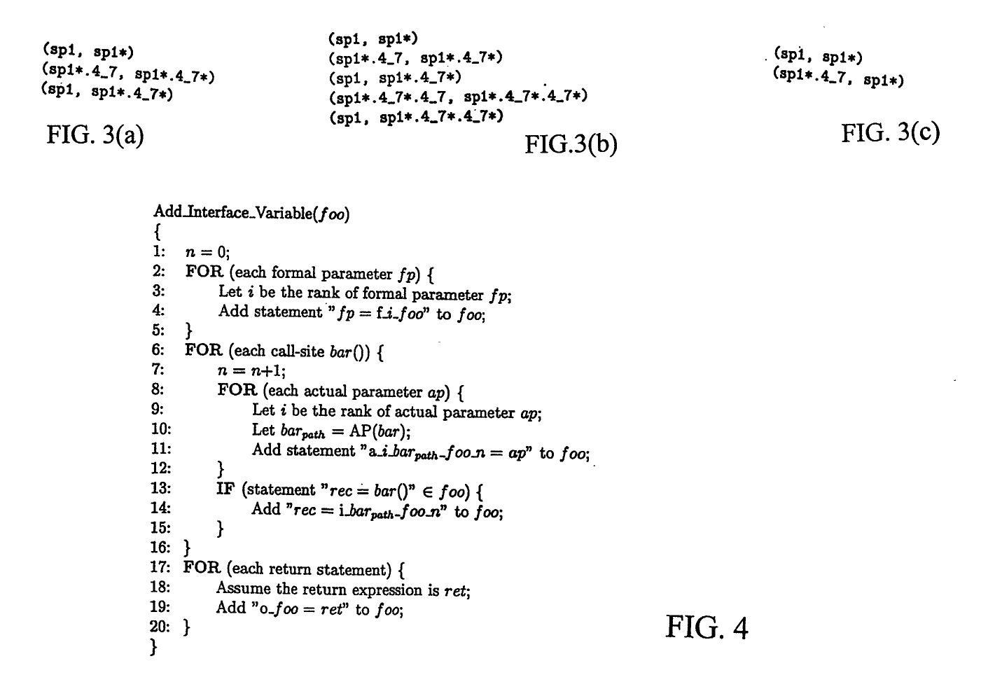

Consider the common pointer-chasing statement sp1=sp1→ next in a linked-list traversal loop where sp1 is a formal parameter. It will be shown later that pointer assignments need to be analyzed iteratively otherwise the resolved points-to relations are not complete. When the statement is analyzed for the first time, the resultant points-to relations are shown in FIG. 3. Path sp1* is created when evaluating the prefix path sp1* in the RHS path sp1*.4_7* according to Rule 11. The field operator .4_7 is then appended to sp1*, then sp1*.4_7* is produced since sp1*.4_7 is also an uninitialized pointer.

In the second iteration, sp1 will be found to point to spi* and sp1*.4_7*. Therefore when evaluating the RHS access path sp1*.4_7*, the evaluation result of the prefix path sp1* is {sp1*, sp1*.4_7*}. So when sp1*.4_7 is evaluated, path sp1*.4_7*.4_7 is added, then when sp1*.4_7* is evaluated, path sp1*.4_7*.4_7* is added. When iteration 2 finishes, as shown in FIG. 3, a new points-to relation (sp1, sp1*.4_7*.4_7*) will be found in the points-to relation set. Inductively, the analysis will iterate forever and after the nth iteration, (sp1, sp1 *.(4_7*)ⁿ) is produced.

To address this problem, a recursion-sensitive parameter k is introduced which differentiates the first k objects in a linked list accessed from an uninitialized pointer. As defined in Rule 12, if no more than k prefix paths of path θ which corresponds to an uninitialized pointer has the same recursive data type as the intended target access path, a “*” symbol is appended after the pointer path like the case of Rule 11. Otherwise, the longest prefix path with the same recursive data type is reused as the right-most access path of the pointer's target. The implication is that after the kth instance of recursive objects in a linked list, a cycle is always assumed to exist and all later instances of recursive objects are collectively represented by the kth object. This is similar to the k-limiting approach used in Landi et al., “A Safe Approximate Algorithm for Interprocedural Pointer Aliasing”, but only the lengths of access paths involving recursive data types are controlled. FIG. 3 shows the limited representation of recursive access paths where k is set to 1. When evaluating spi*.4_7*, the types of sp1* and sp1*.4_7* are both S. Since sp1* is a prefix path of sp1*.4_7*, points-to relation (sp1*.4_7, sp1*) instead of (sp1*.4_7, sp1*.4_7*) is generated. Because C is not a strong-typed language, each expression may have more than one type due to type casts, implying each access path may have more than one type as well. However, the total number of types is still bound in a program, and a prefix can subsume a suffix path as long as they have partial overlaps in associated types.

Based on the previously illustrated definitions of access paths and path-based points-to relations, there are two major tasks performed in the intraprocedural stage of the invention: code transformation and pointer analysis. Their rationale and pseudo codes are explained with a detailed example.

### CODE TRANSFORMATION

When a function is analyzed as an isolated compilation unit, its formal parameters are assumed to have unknown values, so indirect accesses from these pointers will be represented by access paths initiating from formal parameters. To determine the actual location denoted by the path in a caller function, it can be determined by replacing the formal parameter with the corresponding actual parameter and following the points-to relations found in the caller. However, formal and actual parameter pairs are unaccounted for, since formal parameter can be named arbitrarily by the programmer, and actual parameters can be arbitrarily complex C expressions. Instead of grouping each formal-actual parameter pair explicitly, they can, however, be identified through systematically designed interface variables.

There are four categories of interface variables in the method of the invention: formal interface variables, actual interface variables, outgoing return variables, and incoming return variables. The templates of these interface variable are explained below.

f_i_θ oo: the ith formal parameter of function θ oo.

a_i_bar_f oo_n: the ith actual parameter passed to function θ oo from function bar at the the nth call-site.

o_θ oo: the outgoing return value of function θ oo.

i_bar_f oo_n: the incoming return value from callee bar in function θ oo of the nth call-site.

The initial field of each interface variable is designed to distinguish its category. The other fields in interface variables have their special meanings to guarantee the uniqueness of an interface variable in the same function or across function boundaries:

i: distinguishes individual parameters in a parameter list.

θ oo: distinguishes parameters in different functions.

bar: distinguishes actual parameters passed to to different callees.

n: distinguishes multiple call-sites to the same callee in the same function.

FIG. 4 lists the pseudo code of the placement of interface variables. The idea is that all right-most access paths that would stem from the original formal parameters and incoming function return values are now represented by paths that stem from interface variable. This can be guaranteed by Definition 3 and the algorithm listed in FIG. 4 since formal interface variables and incoming return variables appear as the right-most expressions in each function. In addition, all paths that are accessible from complex actual parameters and outgoing return values can be easily grasped from their interface counterparts due to their associated points-to relations created by the interface assignments. Line 0 initializes the co-site counter which is incremented by I for every call-site at line 7. Lines 2 through 5 insert interface formal variables and assign them to original formal parameters, while lines 13 to 15 handle callee return values according to similar rules. The field barₚₐₜₕ means the access path of the function call expression, which is either simply a function name for a direct call, or the directly encoded access path of the indirect call expression. Lines 8 to 12 insert interface actual parameters which are assigned by original actual parameters, where line 17 to 20 insert interface outgoing re-turn values. From these interface variables, the targets of actual parameters and return values can be easily identified.

### POINTER ANALYSIS

Pointer assignments in each function are analyzed by their lexical order to calculate the points-to relations. The analysis is conducted iteratively until no new points-to relations are created. Although the analysis is flow-insensitive, meaning that a later assignment will not kill an earlier definition anyway, analyzing the function following the lexical order can reduce the total number of iterations since right-most access paths will emerge earlier.

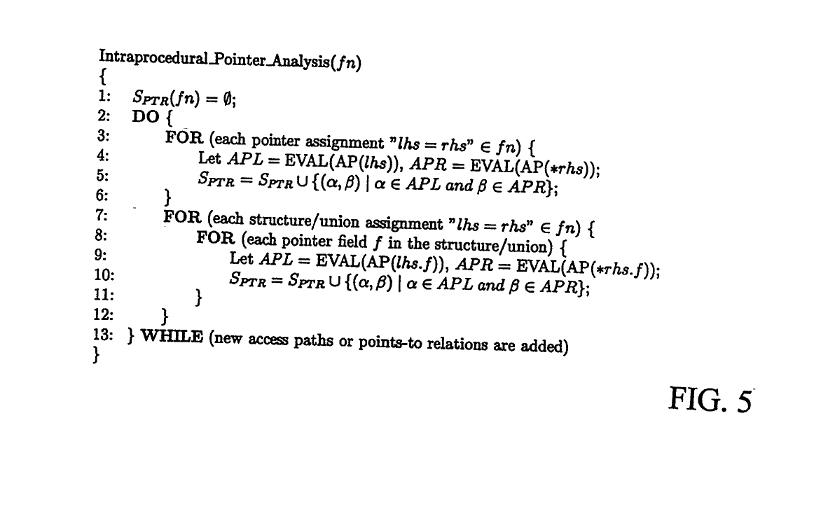

FIG. 5 shows the intraprocedural pointer analysis algorithm after interface variables have been inserted. For assignments involving a whole structure, points-to analysis is performed for each individual pointer field, as shown in lines 7 to 12. When the algorithm terminates, all pointer assignments made to indirectly accessed memory locations through formal parameters will result in points-to relations involving access paths with formal interface variables, and memory locations that can be accessed by callee functions can be found by following the points-to relations from actual interface variables.

### EXAMPLE

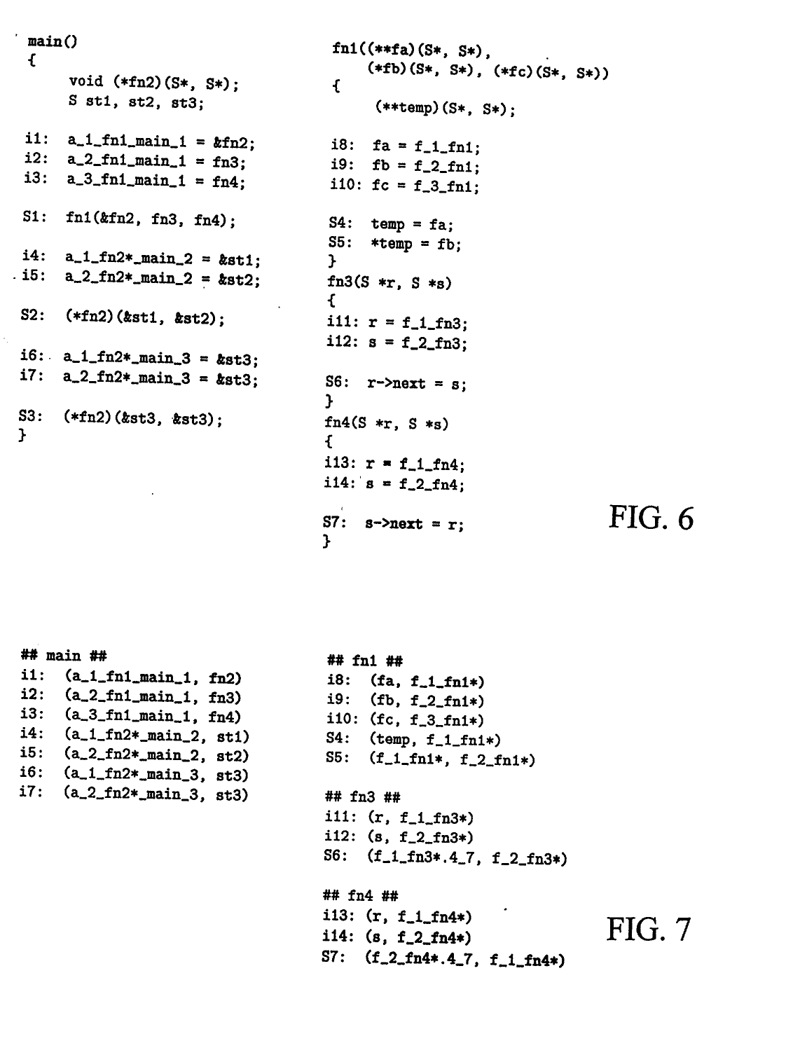

An example is used here to explain the insertion of interface variables and the results of intraprocedural pointer analysis. Shown in FIG. 6, statements with labels in are extra interface statements to enable interface variables to participate in the generation of right-most access paths and points-to relations. Statements i4 and i5 are worth mentioning here since the actual parameters are passed to an indirect callee. Before the indirect call-site is resolved, the callee name is simply the encoded access path of the call expression, which is fn2* in this case. With these interface variables in place, FIG. 7 shows the corresponding intraprocedural pointer analysis results of the code example. The corresponding source statement labels axe put along with each points-to relation for reference. For example, the side-effect of statement S6 of function f n3 is represented by points-to relation (f_1_f n3*.4_7, f_2_fn3*), which can be clearly interpreted as the second word field of the indirectly accessed structure object from the first parameter will point to whatever location pointed to by the second parameter.

### INTERPROCEDURAL POINTER ANALYSIS

When the iterative intraprocedural pointer analysis finishes, pointers that are defined by local assignments can be resolved. Many points-to relations are therefore generated in the intraprocedural phase, but points-to relations involving memory locations that can be accessed across function boundaries are handled in the interprocedural phase. However, some information is still missing, including the concrete values passed to formal parameters and global variables, and the contents of pointers that are modified by pointer assignments in invoked functions. These missing parts will be analyzed in the interprocedural stage.

The tasks performed in the interprocedural phase are carefully staged to reduce the memory and analysis time requirements. First, a summary behavior for each function is extracted. A summary behavior is a subset of function-level activities that can interact with activities in other functions. For example, memory accesses to local variables whose addresses are never taken need not to be analyzed in the interprocedural stage since the scope of their lifetime is strictly limited within the function. Then, the core of the interprocedural pointer analysis is entered, including three iterative phases followed by two acyclic phases. Operations conducted in the iterative phases involve the construction of the call graph, and the propagation of summary transfer functions and concrete function-type parameter values along the call graph. Then, operations conducted in the acyclic phases are much simpler since the major job is to determine the aliases among parameters. Details about the summary behavior extraction will be presented first, followed by the explanation of individual phases in the interprocedural pointer analysis stage.

### SUMMARY BEHAVIOR EXTRACTION

A function in a C program often starts with a list of parameters, followed by a set of local variable declarations, and a set of statements that perform computations. Among these many computation activities, only the following types of information need to be maintained in the interprocedural stage:

1. Caller-allocated locations. Memory locations that are allocated by the caller can be accessed by the callee if their addresses are passed through formal parameters or global variables. Identifying these locations is critical to guarantee the correctness of load/store optimizations performed for the callee function body. If a certain combination of concrete values passed from one calling context causes two accesses to be aliases, unless function cloning is performed, the alias relation should be respected by the optimizer for all calling contexts. Whether a C expression will access the memory or not can be determined by the rules listed in Table 1. Among many C expressions, only five forms of non-array type expressions can access the memory: direct accesses through variable names, field accesses through structure/union names/addresses, indirect accesses through pointers, and indirect accesses through base addresses and indexes. However, a memory expression's parent expression may decide whether to bypass the memory access or not since sometimes the memory content is of no interests to the computation. For example, expression i accesses the content of variable i, but expression &i does not access the memory since all it needs is the address of i, which is irrelevant with i's content. Similarly, expression (size of i) does not access the memory either since the result of the expression is determined by its type. In fact, sometimes it is the grand parent expression which determines the existence of memory accesses. For example, expression ((int) i) accesses the content of i, but &((int) i) does not, even though type cast (int) is the immediate parent expression in both cases. It is because some C operators only have syntax significance instead semantic significance, and only semantic-significant parent operators determine whether the memory needs to be accessed or not. In C, type casts and parentheses only have syntax significance, so they are not considered as significant parents in determining memory accesses. As shown in the top row of Table 1, parent operators like &, ., and size of do not care about the content of the child expression, so the implied memory access is not performed. On the other hand, semantic-significant parent operators like →, *, [], and other unary/binary operators need the content of the child expression for computation or memory dereference, so the implied memory access in the child expression is performed.

TABLE 1
Rules of identifying expressions causing memory accesses.

| | | Semantic-Significant Patent Operators | |
|---|---|---|---|
| | | Content Irrelevant | Convent Relevant |
| | | &, ., sizeof | ∅, −>, *, [], other unary/binary operators |
| Non | var | NO | YES |
| Array | . | | |
| Type | −> | | |
| * | | | |
| | [] | | |

Before register allocation, each identified memory access will have a corresponding load or store instruction in the low-level code, and whether such a memory instruction accesses locations that are also accessible by the caller or not can be easily determined by checking the right-most access paths found by the EVAL function for the directly encoded access path: if path elements starting from formal interface parameters or global variables are found in the evaluation result, they are caller-allocated locations. Each such access path then will be annotated with the MOD/REF attributes inherited from the C expression. These attributes will be analyzed by the optimizer when memory instructions are scheduled across jump-subroutine-call (jsr) instructions. More optimizations details will be given in Chapter 5.

2. Summary transfer function. Since expressions in the callee function may access caller-allocated locations through pointer-type parameters or global variables, the caller function needs to be aware of any new modifications made to these locations by assignments in the immediate or descendant callees. A summary transfer function collectively represents the side-effects of these assignments, and in the context of interprocedural pointer analysis, a summary transfer function is represented by a set of points-to relations.

Assignments to caller-allocated pointers by local assignments in the callee will be explicitly represented by points-to relations whose pointer and target paths both originate from formal interface parameters or global variables. It is because the E- VAL function is defined to find the source variable of a chain of pointer definitions and truthfully append a sequence of dereference and offset tokens after the source variable. In addition, the invoked function may allocate heap objects for the caller to use. Since these heap-objects may be of pointer types and may be initialized by statements in the callee, they should also be considered as parts of the summary transfer function of the callee. For these objects to be used by the caller, their addresses must be assigned to formal parameters or global variables. However, since formal parameters and global variables are assigned with heap-objects' addresses, these pointers are not uninitialized any more, meaning accesses to these heap objects will not be normalized to right-most access paths stemming from interface formal parameters and global variables. Once these heap objects are identified, their associated points-to relations are also included in the summary transfer functions.

3 . List of invoked functions. Points-to relations extracted by the above two aspects only represent the side-effects of local statements but not the side-effects of further invoked function calls. These single-level summary transfer functions will be propagated along the call graph in later phases of the interprocedural pointer analysis stage so that the targets of pointers initialized across multiple-level function calls will be contained in the immediate callee functions' summary transfer function. To facilitate the call-graph construction algorithm which will be described later, each function's summary behavior includes a list of callee function names. In the presence of indirect calls, the directly encoded access path of the indirect call-site is temporarily considered as the callee name. If the EVAL result of an indirect call-site path contains right-most access paths starting from formal interface parameters or global variables, they are also kept in the summary behavior since they contain information about how to resolve this function pointer across function boundaries.

4. Assignments involving uninitialized pointers. When the EVAL function is invoked, intermediate pointers in the input access path are processed to identify their targets. When an uninitialized pointer is reached, all remaining dereference and offset tokens in the input path will be transferred and appended after the access path denoting the uninitialized pointer. Therefore, the temporary right-most access paths from uninitialized pointers still contain enough information indicating how many more levels of dereferences and offset adjustments to apply once the pointer is resolved. In the interprocedural pointer analysis stage, uninitialized pointers may be resolved through pointers passed down from callers or after applying the transfer functions of the callees. There are two problems to resolve: how to determine pointers that could be defined interprocedurally and how to re-run the EVAL function to generate the up-to-date right-most access paths, and therefore to generate the up-to-date points-to relations.

To address the first problem, an access path involves pointers that could potentially receive new definitions in the interprocedural stage if the access path initiates from a formal interface parameter or a global variable, or the path is accessible through a depth-first-search (DFS) from an actual interface parameter or a global variable. To address the second problem, any existing access path involving a prefix path which qualifies as a pointer that could be potentially defined interprocedurally is processed by the EVAL function again and the evaluation result will include all new right-most access paths. These new right-most access paths will inherit the same MOD/REF and type information from the input access path. Then, if a points-to relation's pointer path or target path involves a prefix path which qualifies as a pointer that could be potentially defined interprocedurally by the aforementioned rule, both the pointer and target paths in the original points-to relation are evaluated. The cross-product points-to relations added between the evaluation results of the pointer path and the target path will accommodate all new points-to relations.

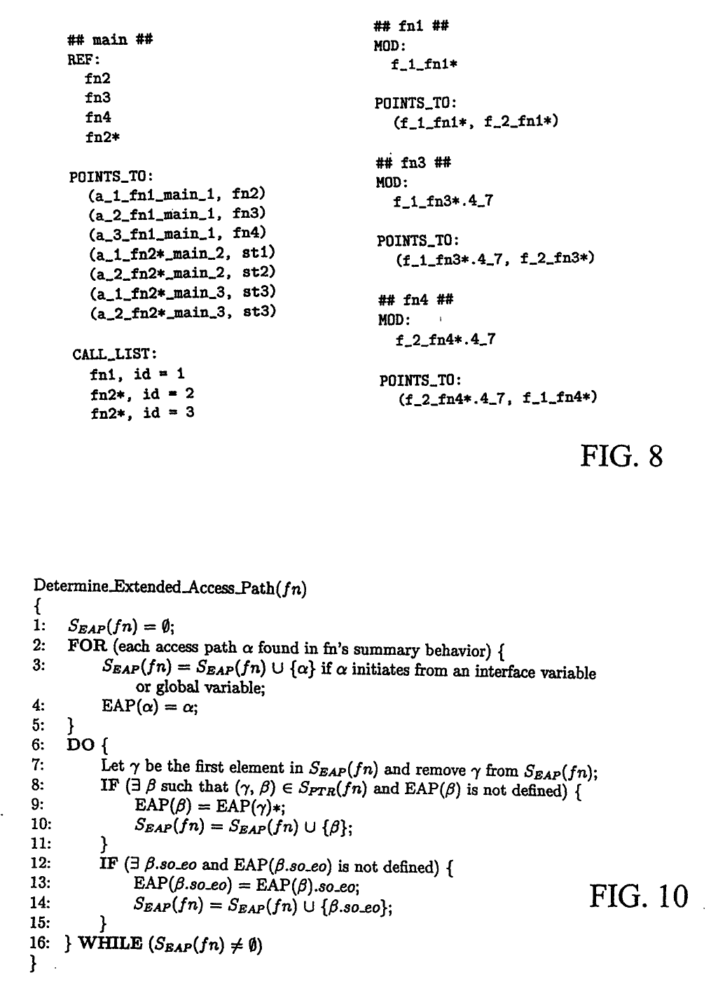

As an example, FIG. 8 shows the summary behavior of functions listed in FIG. 6. The MOD/REF sections exclude direct accesses to interface variables since they are inserted only for analysis purpose and real code will not be generated for them. Similarly, direct accesses to local variables whose addresses are never passed to other functions need not be included in the summary behavior either. Some points-to relations shown in FIG. 7 are not included in the summary behavior if the pointer path represents a local variable or a formal parameter which cannot be accessed interprocedurally. For example, points-to relation (temp, f_1_fn1*) of function fn1 is not included in its summary behavior since temp's address is not taken. However, points-to relation (f_1_fn1*, f_2_fn1*) is included since both the pointer and target paths represent caller-allocated locations. It is only the summary behavior instead of the whole function body to be maintained in the interprocedural stage. This greatly improves the memory requirement of the algorithm, and as will be shown later, maintains context-sensitivity for transfer functions.

### ALGORITHM OF INTERPROCEDURAL POINTER ANALYSIS

The interprocedural stage of the present pointer analysis algorithm has three iterative phases followed by two acyclic phases as shown in FIG. 2. The fundamental tasks performed in these phases are similar to RCI Chatterjee et al., “Relevant Context Inference”, so the same major phase numbers are used, though significant operational differences exist in the manner that the phases are conducted.

### PHASE 0: CALL GRAPH CONSTRUCTION

Starting from the callee list in the summary behavior of function main, the call graph can be iteratively constructed performing a DFS (depth first search). If the program has no indirect function calls, the complete call graph can be constructed in the first invocation of phase 0 analysis. Otherwise, as opposed to approaches which over-estimate the call graph based on function signatures, functions invoked through indirect call-sites are temporarily excluded from the call graph, thus underestimating the call graph. Through studies over larger programs like the SPEC benchmarks, many indirectly invoked functions share the same function signatures but are called from different call-sites, therefore the estimated call graph will be too large which both affects the accuracy and lengthens the analysis time of the interprocedural stage.

In the current mechanism, each unresolved indirect call-site is represented by the encoded access path of the indirect call expression. Through the points-to relations discovered from the side-effects of callees or from the concrete function names passed via formal parameters, an indirect call-site can be resolved by evaluating the temporary right-most access paths of the corresponding call site. An indirect call-site may be resolved to have multiple possible callees. Since the present interprocedural pointer analysis algorithm is flow-insensitive in terms of the side-effects of local assignments and the transfer functions of callees, and is context-insensitive in terms of parameter aliases, these multiple callees will not be further differentiated.

The constructed call graph, which could be incomplete in the middle of the iterative process, is partitioned into strongly connected components and viewed as a strongly connected component directed acyclic graph (SCC-DAG). See, Cormen et al., Introduction to Algorithms, the MIT Press. That is, the SCC node containing function main is considered as the root of the SCC-DAG, and functions in a recursive chain are grouped as a single SCC node. Then these SCCs are sorted by a bottom-up and a top-down topological order with respect to the root node, the summary behavior of function main. As will be explained in the next two phases, abiding by these orders can shorten the number of iterations of the analysis.

### PHASE I: PROPAGATION OF SUMMARY FUNCTIONS AND CALLEE-ALLOCATED HEAP OBJECTS

The problems to be dealt with in the phase I″ analysis include what to propagate, where to propagate, and when to propagate. As briefly mentioned before, caller-allocated locations and newly allocated heap objects need to be propagated. The propagation is simply conducted by replacing the formal parameter variable in an access path with corresponding actual parameters in the calling contexts, resulting a context-sensitive representation of summary transfer functions. And the propagation is conducted following a bottom-up topological order of the SCC-DAG since the caller's transfer function should include summary transfer functions of all invoked callees, including callees invoked through more than one level of function calls. Given h as the maximum height of the SCC-DAG, propagating summary transfer functions in a top-down order may require h iterations of the analysis, while only one iteration is required in a bottom-up order. After a function receives propagated points-to relations from the summary transfer functions of all callees, existing points-to relations involving unknown variables are evaluated to augment the summary behavior with new right-most access paths and points-to relations. Then the information contained in the summary behavior is ready to be propagated to further callers.

Let (rα, sβ) be a points-to relation in function fn's summary behavior where r, s are formal interface parameters or global variables, and α, β are two suffix access paths. If sβ is not symbolically represented as rα*, meaning that rα is not an uninitialized pointer, this points-to relation obviously should be considered as part of the summary transfer function of fn since it reflects a pointer assignment which can affect a caller-accessible pointer. Since a pointer field in a structure object may point to another field in the same structure object, r and s may be the same variable.

Definition 5. (Propagation of points-to relations). Let (rα, sβ) be a points-to relation in function fn's summary transfer function where r,s are formal interface parameters or global variables, and α, β are two suffix access paths. The propagated points-to relations of (rα, sβ) to caller fm are: {(δ,θ|∃δεEVAL(aα, S_{PTR}(fm)) and ∃θεEVAL(bβ, S_{PTR}(fm)) is a global variable. Otherwise a is the corresponding actual parameter in fm. The same relation holds between b and s.

As shown in Definition 5, the first step of propagating such a points-to relation from the callee to the caller is to identify what locations are denoted by the pointer access path and the target access path in the caller, respectively. Access path rα simply states that from variable r, the final memory location is accessed via a sequence of dereference and offset adjustment operations denoted by α. Since the dereference and offset adjustment operations are context-independent, they are applicable to all calling contexts. As long as the formal parameter in the access path is replaced by the corresponding actual parameter and the transformed access path is evaluated in the caller's context of points-to relations, the denoted locations by the access path can be discovered in a context-sensitive manner. If the caller passes the address of a local variable to the callee, the local variable's name will appear as a right-most access path in the evaluation result. If the caller passes a pointer value received from formal parameters or global variables further down to the callee, the evaluation result will convey the dereference and offset tokens to the source formal parameters or global variables, meaning the caller's summary transfer function is augmented to accommodate the callee's summary transfer function and will be reported to grand callers. Since the formal parameters of the caller are still considered uninitialized in the interprocedural stage, the augmented transfer function is still context-independent.

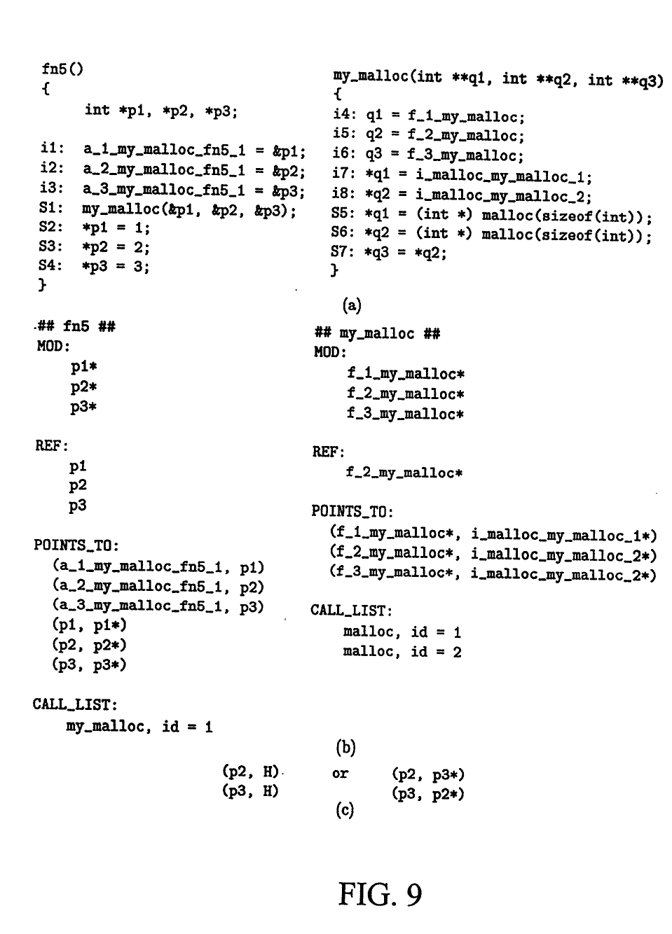

The next interesting question is how dynamically allocated objects are handled by access paths and their existences are propagated across function boundaries. Instead of generating pseudo variable names using synthesized call-site paths, heap objects are named by access paths which are differentiated by interface variables and suffix dereference and offset tokens. If the heap objects are allocated through calling malloc directly via local statements, these objects are named in the form of i_malloc_foo_n*, (see FIG. 9), assuming θ oo is the name of the function containing these calls to malloc. Since n is a unique number assigned to each call-site, multiple heap objects allocated in the same function via different call-sites can be effectively distinguished. If the heap objects are allocated through calling wrapping functions, these objects are aggressively distinguished by different access paths extended from different variables or different suffix access paths appended after the same variable. That is, all heap objects allocated through calling wrapping functions are assumed to be independent unless they are proven to be dependent.

Consider the example shown in FIG. 9. In function fn5, there are three integer pointers p1, p2, and p3, and through calling my_malloc, two instances of heap-based integer objects are allocated. In function my_malloc's summary behavior, these two objects are uniquely named as i_malloc_my_malloc_1* and i_malloc_my_malloc_2*, respectively. Before propagating these heap objects from my_malloc to fn5, p1, p2, and p3 are assumed to point to disjoint locations as denoted by p1*, p2*, and p3* in FIG. 9b. However, in this example p2 and p3 point to the same location, and disregarding this fact may cause write after write (WAW) hazards for statements S3 and S4. There are two options to represent the dependence as either creating an explicit right-most access path like H, a special form of artificial variables for heap objects, in FIG. 9c, or adding at least one of the two points-to relations from p2 to p3* or from p3 to p2*. The advantage of the latter option is that it requires no special representation for heap objects, therefore it is dissertation and the algorithm used to detect the dependence is presented in FIG. 10.

The basic idea behind the algorithm is that if a callee function allocates a heap object for the callee to use, the object must be reachable by conducting a DFS following the points-to relations initiated from formal interface parameters and global variables. An extended access path, or EAP, can be considered as a reverse-engineered access path obtained from DFS and indicates a potential way for the object to be accessed from a parameter or a global variable. Set S_{EAP} is the working list containing access paths whose EAPs have been determined, where lines 2 to 4 fill S_{EAP} with access paths starting from interface variables and global variables. The EAPs of these access paths are simply the access paths' name. For example, the EAP of path f_1_my_malloc* is f_1_my_malloc* itself.

Lines 6 through 16 process elements in the working list and determine the EAPs based on the relative access paths. Given a points-to relation (γ, β) lines 8 to 11 determine the EAP of β by appending a “*” after the the EAP of γ. The reason is obvious since the location denoted by β can be reached from the location denoted by γ through one level of dereference. Due to the nature of aliases, an access path may have multiple ways to be accessed, therefore an access path may have more than one potential EAP. The present algorithm defines that the first EAP found for an access path is chosen as the persistent name to be viewed by the caller. For example, i_malloc_my_malloc_1* has a unique EAP as f_1_my_mallloc**, but i_malloc_my_malloc_2* may be assigned as f_2_my_mallloc** or f_3_my_mallloc**, depending on whether the DFS is performed from f_2_my_maillloc or f_3_my_mallloc first. In the particular case where the DFS is performed from f_2_my_mallioc before from f_3_my_mailloc, the EAP of i_malloc_my_malloc_2* is f_2_my_mallloc**. After the EAPs of aggregates are determined, lines 12 to 15 determine the EAPs of enclosed fields.

In fact, the constituent points-to relations in the summary transfer function can be identified solely by EAPS. If an access path's EAP is not defined, it means that the denoted location is not accessible by the caller, therefore points-to relations with EAP-less access paths axe not considered as part of the transfer function. If the pointer path in a points-to relation is EAP-less, the target path is definitely EAP-less since it will never be put into the working list. Definition 5 may be modified to propogate not only access path denoting stack locations in the caller functions, but also heap objects allocated by callee functions. The modified definition, which propagates transfer functions and detects dependence among accesses to heap objects, is given now as definition 6.

Definition 6. (Propagation of summary transfer functions using EAPS). Let (γ,λ) be a points-to relation in fn. It is part of fn's transfer function if EAP(γ)≠∅. Assuming EAP(γ)=rα and EAP(λ)=sβ, r and s must be formal interface interface parameters or global variables. The propagated points-to relations of (γ, λ) to caller fm are: {(δ, θ)|∃δεE EVAL(aα, S_{PTR}(fm)) and ∃θεEVAL(bβ, S_{PTR}(fm))}. The conditions are identical to those in Definition 5.

With BAPs and Definition 6, the points-to relation from path f_{—}3_my_malloc* to path i_malloc_my_malloc_2* is included in my_malloc's transfer function. The transfer function is represented as (f_{—}3_my_malloc*, f_{—}2_my_malloc**). After propagating that from my_malloc to fn5, the points-to relation from p3 to p2* will be added. Otherwise if the DFS is performed for q3 before q2, points-to relation (p2, p3*) will be added. It does not matter which one is actually added, as long as EVAL(p2*, S_{PTR}(fn5))∩EVAL(p3*, S^{PTR}(fn5))≠∅ is true since it asserts the dependence of two memory accesses, which will in turn assert the correct execution order of statements S2, S3, and S4.

In addition to summary transfer functions, the summarized MOD/REF memory accesses are also propagated to caller functions. The purpose is to augment the caller's summary behavior so that it also summarizes the footprints of memory accesses of all invoked single level or multi-level callees.

### PHASE II: PROPAGATION OF FUNCTION NAMES

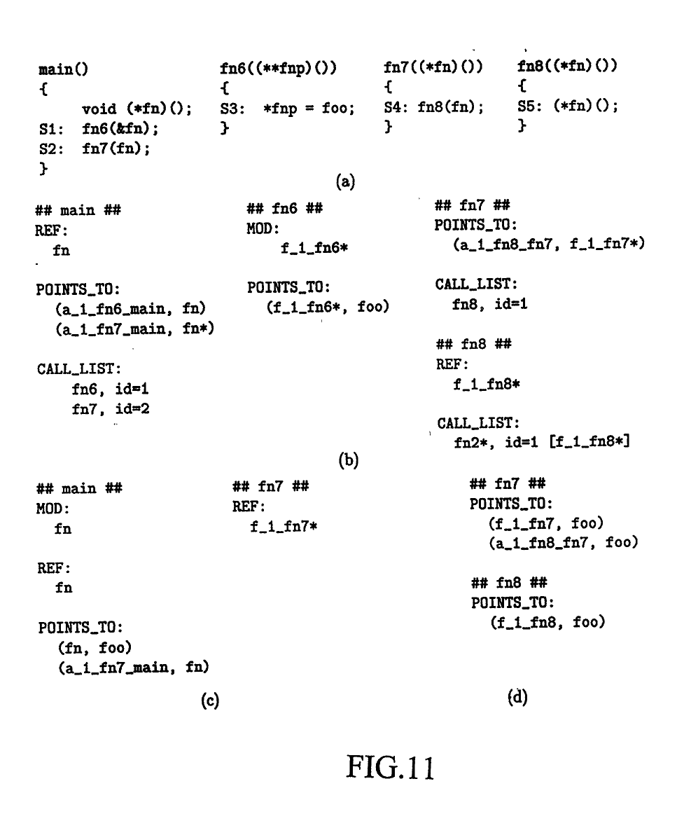

In modern programming languages which support indirect function calls, a function pointer may receive values through local assignments, callees' side-effects, or through values passed via formal parameters. For the first case, it is resolved in the intraprocedural pointer analysis stage; for the second case, it is resolved in the phase I″ analysis of the interprocedural stage when the summary transfer functions of the callees are propagated. The analysis conducted in phase 11′ of the interprocedural stage is to resolve function pointers initialized by the third case. If a function pointer is resolved in the intraprocedural stage, a native function name should appear as a right-most access path of the directly encoded access path of the call-site. If a function pointer is resolved by accommodating the side-effects of the callees, re-evaluating the access path of the indirect call-site will find the propagated function name. If a function pointer is resolved through formal parameters, a right-most access path associated with the call-site access path and initiated from a formal interface variable should be found in the REF section of the callee function. To search for the potential function names passed down from callers, the right-most access path is first transformed with the actual formal parameter replacement and then is evaluated in the caller's scope. If the evaluation result contains concrete function names, meaning the function pointer is resolved, they are propagated down to the callee's summary behavior. If parameter-based access paths instead of concrete function names are found, the REF section of the caller function's summary behavior will be augmented and it will be the caller's responsibility to search for concrete function names from further callers, even though the indirect call-site is not contained in the caller function. FIG. 11 shows an example where the indirect call-site in function f8 uses the value passed through a parameter which is initialized in function f6. The function body of foo is omitted here since it is irrelevant. The summary behavior of each function is shown in FIG. 11b. Access path f_1_fn8* shown in square braces is a right-most access path associated with the call-site path fn2* in fn8's summary behavior, and the right-most access path is found by conducting EVAL(fn2*, {(fn2, f_1_fn8*)}).

FIG. 11 shows the propagated access paths and points-to relations for each function after invoking the phase I″ analysis for the first time. Function f6's summary behavior indicates that the dereferenced location from the first formal parameter is modified, so the MOD section of main is added with path fn, which is the result of EVAL(a_1_fn6_main*, {(a_1_fn6_main, fn)}). Similarly, points-to relation (fn, f oo) is propagated into function main from f6. Now fn* is not a right-most access path since fn has outgoing points-to relations. After re-evaluating points-to relation (a_1_fn7_main, fn*) a new points-to relation (a_1_fn7_main, foo) is also added. Along with the other SCC chain in the call graph, path f_1_fn7* is propagated to the REF section of fn7 from fn8, and in turn it is propagated to the REF section of main as fn*. Since the MOD/REF sections in a summary behavior are augmented to include caller-allocated locations accessed not only by local expressions but also by invoked callees, the top-down propagation of concrete function names are conducted in a lazy manner: each function only requests concrete function names for access paths found in the REF section from immediate callers, and each function never communicates with functions other than immediate callers or callees.

Definition 7. (Concrete value retrieval). Let rα be an access path in function fn's REF section and rα* is also found in function fn's MOD or REF sections, where r is a formal interface parameter or a global variable, and a is a suffix access path. The targets pointed by concrete values passed via ra from caller fm are: {θ|∃δεEVAL(aα, S_{PTR}(fm)) and ∃(δ, θ)εS_{PTR}(fM)} where a=r if r is a global variable. Otherwise a is the corresponding actual parameter in fm.

Definition 7 shows how to retrieve concrete values from callers. Since a structure may contain multiple scalar fields, where some fields may be pointers to other structures, a single structure-pointer parameter may convey multiple concrete values to the callee. So the actual-formal parameters binding is performed not only for simple variables, but also for access paths starting from formal interface parameters and global variables. Since there are many fields that can be, but are not, used to convey values from a particular caller to a particular callee, concrete values are retrieved lazily only dereferenced pointers found in the immediate or deeper callees are bound. So in this example, function fn7 searches its MOD/REF sections and finds path f_1_fn7*, which stands for an indirect access through a function pointer. According to Definition 7, the corresponding access path of f_1_fn7* in function main is a_1_fn7_main*. The result of EVAL(a_1_fn7_main*, {S_{PTR}(main)}) is {foo}, so a new points-to relation is propagated down to f7 as (f_1_fn7, foo), shown in FIG. 11d. Now f_I_fn7* is not a right-most access path, and after re-evaluating points-to relation (a_1_fn8_fn7, f_1_fn7*), a new points-to relation, (a_1_fn8_fn7, foo), can be added. When function fn8 requests the content of the function-pointer parameter f_1_fn8, the concrete function name foo can be discovered and the indirect call-site in f8 can be resolved.

### PHASE II″: PROPAGATION OF ALL CONCRETE VALUES

Phase II″ analysis is conducted after the fixed point of phases (0_1″-11′)* is reached. At this moment the complete call graph should have been constructed. Then, along a top-down topological order of the SCC traversal, access paths representing deferences of formal parameters and global variables in the MOD/REF sections are bound with their concrete values passed from the callers. Unlike the phase II analysis which only retrieve function-type concrete values, all types of concrete values are retrieved in this phase, and the retrieval is also conducted lazily for dereferenced pointers only.

### PHASE III: IDENTIFICATION OF PARAMETER ALIASES

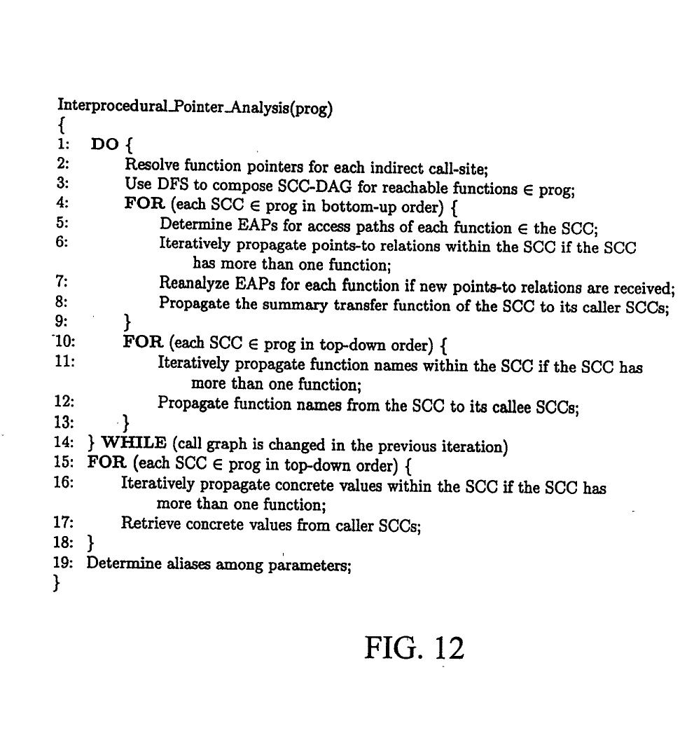

Among many concrete values passed down from callers, only a small portion of them are necessary. For example, passing the address of a local variable as an actual parameter is insignificant unless the same address is passed through two different caller-accessible pointers, and both pointers are dereferenced by the callee. So in the phase III analysis, if the evaluation result of an access path found in the MOD/REF sections never has common right-most access paths with the evaluation results of other access paths, its bound values are excluded from the summary behavior since the memory access is always independent with other parameter dereferences across all calling contexts. The trimmed summary behavior will be merged into each function to guide code optimizations. The pseudo code listed in FIG. 12 summarizes various phases of analyses conducted in the interprocedural stage.

### ISSUES ABOUT LIBRARY FUNCTIONS

Many commonly invoked library functions have side-effects that can be used as alternative ways to initialize pointers. For example, given two pointers p and q, a library call in the form of memcpy (&p, &q, 4) achieves the same effect as the pointer assignment p=q. To accommodate their side-effects appropriately in the interprocedural pointer analysis stage, each library function with side-effects are written with template statements. Although these template statements cannot replace the original functionality of library calls, but the equivalent summary behavior can be derived by analyzing these template statements using the algorithm shown in FIG. 5. For example, the template version of memcpy is written as:

memcpy(void *p, *q, int n)
{

* ((char **) p) = *((char **) q);

}

By analyzing the template statement, the summary transfer function of memcpy will include points-to relation (f_1_mem*, f_2_mem**), which will be processed in the interprocedural stage to expose the effect of the hidden pointer assignment in memcpy.

Currently, there are 186 library functions modeled by template statements in the IMPACT compiler. They cover the library functions invoked by SPECcint92 and SPECeint95, “MediaBench: A Tool for Evaluating and Synthesizing Multimedia and Communications Systems”, and many Unix utility benchmarks. For library functions without pointer assignments, as long as they indirectly access locations via formal parameters, they are also represented by template expressions to obtain their memory access footprints that will be referenced by optimization routines. For example, the template version of function atoi, which converts a string into an integer, is:

atoi(const char *str)
{

char i;
i = str[0];

}

Because of the pseudo expression that uses str [0], access path f_1_atoi* will be posted in the REF section of atoi's summary behavior. So when a code region containing a call to atoi is optimized, a later store to the dereferenced location of the actual parameter passed to atoi will not be scheduled before the function call to avoid the WAR hazard.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A pointer analysis algorithm to resolve pointers in functions of a program at compile time, the algorithm comprising steps of:
identifying pointer assignments for functions of the software program;
representing interprocedurally accessible objects by a path found in a callee which is used to search points-to relations in an associated caller;
for each function of the software program, maintaining a transient set of parameters for the represented path to accessible objects for passing down from a callee to a further callee of an accessible object;
for each function of the software program, maintaining a persistent set parameters for the represented path to accessible objects for reporting to all calling contexts of an accessible object; and
resolving pointers according to the transient and persistent set of parameters for accessible objects having pointer assignments in functions of the software program.

2. A pointer analysis algorithm to resolve pointers in functions of a program at compile time, the algorithm comprising steps of:
conducting an intraprocedural analysis of functions of the software program, the intraprocedural analysis generating possible relations without definite relations of function pointers and resulting in a flow insensitive and context independent summary of the intraprocedural behavior of the functions;
conducting a context sensitive interprocedural analysis of the functions, the interprocedural analysis including
iteratively building a call graph using the summary of the intraprocedural behavior with a bottom up and top down propagation through the program until a fixed point is reached to complete the call graph, and
propagating concrete values along the completed call graph;
calculating aliases among formal parameters in the program.

3. A pointer analysis algorithm to resolve pointers in functions of a program at compile time, the algorithm comprising steps of:
representing direct and indirect accesses in program functions using access paths;
resolving the access paths to fields in aggregate structures by
denoting direct accesses to variables by variable names;
denoting indirect accesses to objects of nonrecursive data types by concatenating encountered dereference and offset operations in order after an initial variable name; and
denoting indirect accesses to objects of recursive data types by concatenating encountered offset operations in order after initial variable name while limiting the number of dereference operations with a specified parameter; and
calculating parameter aliases based on the resolved access paths.

4. A pointer analysis algorithm to resolve pointers in functions of a program at compile time, the algorithm comprising steps of:
resolving aliases among access paths due to pointer assignments in the program by normalizing each access path to its right-most forms using and points-to relations;
resolving aliases among access paths due to unions and type casts in the program using actual byte-level offsets for fields in aggregate structures.

5. A pointer analysis algorithm to resolve pointers in functions of a program at compile time, the algorithm comprising steps of:
naming locally allocated heap objects in the program by access paths comprising unique identifiers associated with each call site of system memory allocation routines;
differentiating callee allocated heap objects by access paths comprising actual parameter names with unique ranks, and unique identifiers of a host call site of the actual parameters;
differentiating caller allocated heap objects by access paths stemming from different formal parameters;
resolving aliases of an access path by a closure function which takes an access path and a set of points-to relations and then returns the set of right-most aliases of the input path; and
repeating said differentiating steps and said resolving step, with the closure function in said resolving step accounting for any points-to relations resolved in previous iterations.

6. A pointer analysis algorithm to resolve pointers in functions of a program at compile time, the algorithm comprising steps of:
conducting an intraprocedural pointer analysis within each function of the program, in accordance with
{
S_{PTR}(fn) = ∅;
DO{
FOR (each pointer assignment “lhs = rhs” ε fn) {
Let APL = EVAL(AP(lhs)), APR = EVAL(AP(*rhs));
S_{PTR} = S_{PTR} ∪{(αβ) |αεAPL and βεAPR};
}
FOR (each structure/union assignment “lhs=rhs” ε fn) {
FOR (each pointer field f in the structure/union) {
Let APL=EVAL(AP(lhs.f)), APR=EVAL(AP(*rhs.f));
S_{PTR} = S_{PTR} ∪{(αβ) |αεAPL and βεAPR};
}
}
}WHILE (new access paths or points-to relations are added)
}
conducting an interprocedural pointer analysis through the program, in
accordance with
{
DO {
Resolve function pointers for each indirect call-site;
Use DFS to compose SCC-DAG for reachable functions ε prog;
FOR (each SCC ε prog in bottom-up order) {
Determine EAPs for access paths of each function ε the SCC;
Iteratively propagate points-to relations within the SCC if the SCC
has more than one function;
Reanalyze EAPs for each function if new points-to relations are
received;
Propagate the summary transfer function of the SCC to its caller
SCCs;
}
FOR (each SCC ε prog in top-down order) {
Iteratively propagate function names within the SCC if the SCC has
more than one function;
Propagate function names from the SCC to its callee SCCs;
}
} WHILE (call graph is changed in the previous iteration)
FOR (each SCC ε prog in top-down order) {
Iteratively propagate concrete values within the SCC if the SCC has
more than one function;
Retrieve concrete values from caller SCCs;
}
Determine aliases among parameters;
}.
